(19) United States
(12) Patent Application Publication
(10) Pub. No.: US 2025/0280260 A1
(43) Pub. Date: Sep. 4, 2025

(54) Filter Setting Method, Filter Setting Device, and Non-Transitory Computer-Readable Storage Medium

(71) Applicant: Yamaha Corporation, Hamamatsu-shi (JP)

(72) Inventor: Futoshi SHIRAKIHARA, Hamamatsu (JP)

(21) Appl. No.: 19/194,158

(22) Filed: Apr. 30, 2025

Related U.S. Application Data
(63) Continuation of application No. PCT/JP2023/023039, filed on Jun. 22, 2023.

(30) Foreign Application Priority Data
Nov. 1, 2022 (JP) 2022-175446

(51) Int. Cl. H04S 7/00

(52) U.S. Cl. CPC H04S 7/305; H04S 7/307

(57) ABSTRACT

A filter setting method includes measuring an impulse response of a room in which a speaker is placed. The filter setting method also includes extracting a late reverberation component of the measured impulse response. The filter setting method also includes detecting a difference between a frequency-amplitude characteristic of the extracted late reverberation component and a predetermined target characteristic. The filter setting method also includes generating a filter coefficient that achieves a frequency response including amplification or attenuation according to the difference. The filter setting method also includes setting the filter coefficient in a filter configured to process an audio signal fed to the speaker.

### CROSS-REFERENCE TO RELATED APPLICATIONS

The present application is a continuation application of International Application No. PCT/JP2023/023039, filed Jun. 22, 2023, which claims priority to Japanese Patent Application No. 2022-175446, filed Nov. 1, 2022. The contents of these applications are incorporated herein by reference in their entirety.

### BACKGROUND

The present disclosure relates to a filter setting method, a filter setting device, and a non-transitory computer-readable storage medium.

JP 3901648 B2 discloses a method for determining frequency characteristics of a space where speakers are installed (for example, concert hall). The method sets a dip filter coefficient according to the frequency response of the speaker space, thereby preventing resonance in the space.

US 2021/377691 A1 describes the propagation of direct sound, early reflection, and a late reverberation component of sound emitted from a sound source into a space, reaching a listener.

The configuration according to JP 3901648 B2 sets a dip filter coefficient using the entire frequency response. While this method enabled the adjustment of not only the standing waves of a room but also other sound components, it required the microphone used for the adjustment to be placed in a listening position.

An object of the present disclosure is to provide a filter setting method, a filter setting device, and a non-transitory computer-readable storage medium for appropriate control of standing waves of a room regardless of microphone positions.

### SUMMARY

One aspect is a filter setting method. The filter setting method includes measuring an impulse response of a room in which a speaker is placed. The filter setting method also includes extracting a late reverberation component of the measured impulse response. The filter setting method also includes detecting a difference between a frequency-amplitude characteristic of the extracted late reverberation component and a predetermined target characteristic. The filter setting method also includes generating a filter coefficient that achieves a frequency response including amplification or attenuation according to the difference. The filter setting method also includes setting the filter coefficient in a filter configured to process an audio signal fed to the speaker.

Another aspect is a filter setting device that includes a processor configured to measure an impulse response of a room in which a speaker is placed. The processor is also configured to extract a late reverberation component of the measured impulse response. The processor is also configured to detect a difference between a frequency-amplitude characteristic of the extracted late reverberation component and a predetermined target characteristic. The processor is also configured to generate a filter coefficient that achieves a frequency response including amplification or attenuation according to the difference. The processor is also configured to set the filter coefficient in a filter configured to process an audio signal fed to the speaker.

Another aspect is a non-transitory computer-readable storage medium storing a program. When the program is executed by at least one processor, the program causes the at least one processor to measure an impulse response of a room in which a speaker is placed. The program also causes the at least one processor to extract a late reverberation component of the measured impulse response. The program also causes the at least one processor to detect a difference between a frequency-amplitude characteristic of the extracted late reverberation component and a predetermined target characteristic. The program also causes the at least one processor to generate a filter coefficient that achieves a frequency response including amplification or attenuation according to the difference. The program also causes the at least one processor to set the filter coefficient in a filter configured to process an audio signal fed to the speaker.

A more complete appreciation of the present disclosure and many of the attendant advantages thereof will be readily obtained as the same becomes better understood by reference to the following detailed description when considered in connection with the following figures.

### BRIEF DESCRIPTION OF THE DRAWINGS

FIG. 1 is a block diagram illustrating a configuration of a speaker device 1.

FIG. 2 is a schematic diagram of a room 100 where the speaker device 1 is installed.

FIG. 3 is a flowchart showing the operation according to a filter setting method.

FIG. 4 shows a time waveform of an impulse response.

FIG. 5 shows an example of the frequency-amplitude characteristic of an extracted late reverberation component.

FIG. 6 shows an example of the frequency-amplitude characteristic of the late reverberation component after smoothing.

FIG. 7 shows an example of the frequency-amplitude characteristic of a filter (equalizer).

FIG. 8 shows an example of the frequency-amplitude characteristic of a filter (equalizer) according to Modification 1.

### DETAILED DESCRIPTION

The present specification is applicable to a filter setting method, a filter setting device, and a non-transitory computer-readable storage medium.

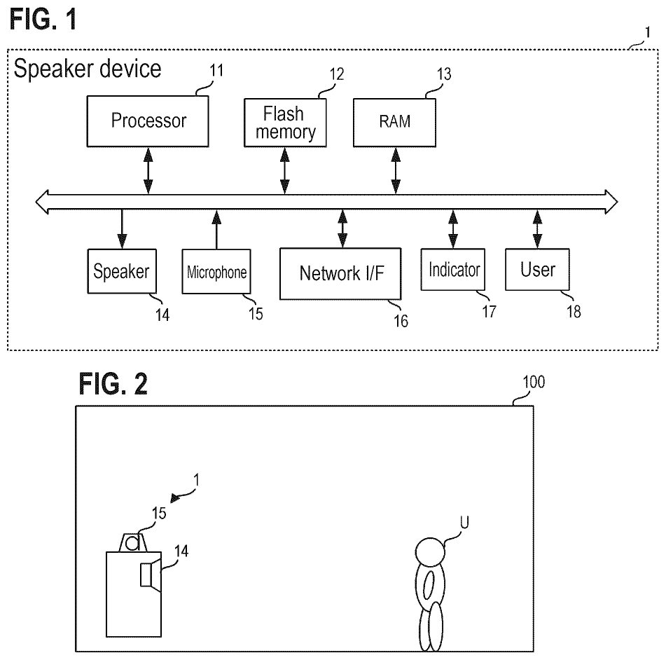

FIG. 1 is a block diagram illustrating a configuration of a speaker device 1 according to an embodiment. FIG. 2 is a schematic diagram of a room 100 where the speaker device 1 is installed.

The speaker device 1 includes a processor 11, a flash memory 12, a RAM 13, a speaker 14, a microphone 15, a network I/F 16, an indicator 17, and a user I/F 18.

The speaker device 1 is an example of the filter setting device. In this embodiment, the speaker device 1 is installed at a predetermined location (for example, near a display showing content-related images) separate from a user U's position in the room 100, as shown in FIG. 2.

The speaker device 1 is connected to a streaming device such as a smartphone, a personal computer, a set-top box, or an audio receiver. The speaker device 1 receives content-related audio signals from these streaming devices. The speaker device 1 may also receive content data from a server via the internet. In this case, the speaker device 1 decodes the received content data to extract audio signals.

The processor 11 is composed of a CPU, DSP, or SoC (system-on-a-chip), and realizes predetermined functions by loading a program stored in the flash memory 12, which is a storage medium, into the RAM 13. For example, the flash memory 12 stores a program for implementing a filter such as an equalizer that adjusts frequency characteristics of an audio signal, and a non-transitory computer-readable storage medium for setting filter coefficients in the filter. The processor 11 implements the filter and the filter setting device for setting a filter coefficient of the filter using these programs. The equalizer may be a parametric equalizer or a graphic equalizer, for example, and may be built with an IIR filter or FIR filter.

The network I/F 16 is a wireless communication unit conforming to standards such as Wi-Fi® or Bluetooth®. The network I/F 16 communicates with one of the streaming devices mentioned above and receives audio signals via wireless communication. The processor 11 applies filtering to digital audio signals received via the network I/F 16 and outputs the signals to the speaker 14, which includes a D/A converter and an amplifier. The speaker 14 emits sound according to the audio signal output from the processor 11.

The indicator 17 includes a number of LEDs, and indicates a standby or power-on status, for example. The user I/F 18 is a power or volume button, for example.

The microphone 15 picks up the sound output from the speaker 14. The processor 11 generates a filter coefficient to be set in the above-mentioned filter based on the sound picked up by the microphone 15.

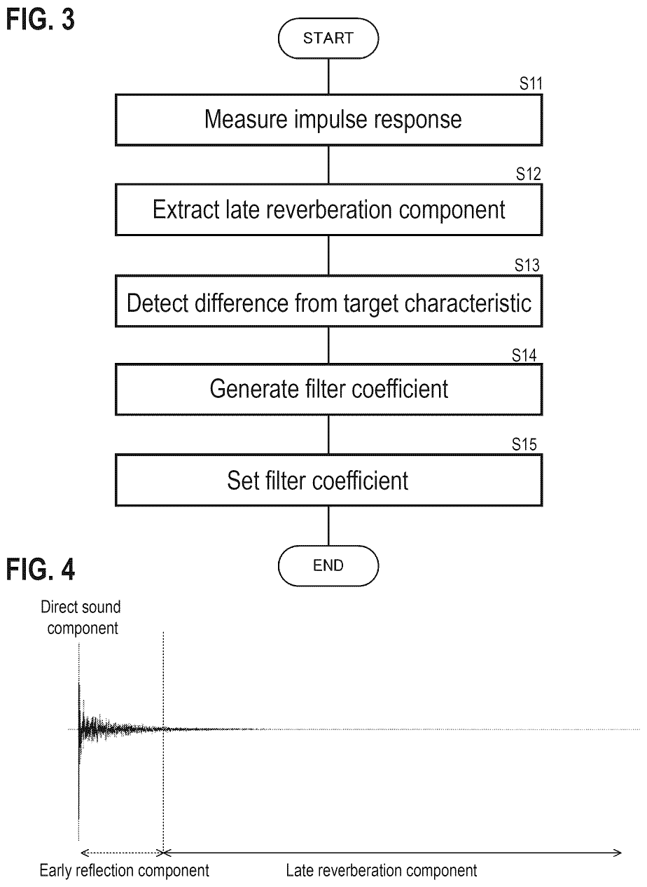

FIG. 3 is a flowchart showing the operation according to the filter setting method. First, the processor 11 measures an impulse response (S11).

More specifically, the processor 11 emits a test sound or a content sound according to an audio signal (for example, a test signal such as an impulse signal, white noise signal, or chirp signal, or a music content signal) from the speaker 14 into the room 100, and generates a signal representing the emitted sound that was picked up by the microphone 15. The processor 11 then calculates the impulse response based on the audio signal (for example, test signal or content signal) and the captured sound signal. For example, the processor 11 calculates a waveform of the impulse response of the room 100 from the captured sound signal using one of known techniques including the cross-correlation method, cross-spectral method, MLS method, and TSP method.

The processor 11 then extracts a late reverberation component from the waveform of the measured impulse response (S12).

FIG. 4 shows the time-series waveform of the impulse response. The horizontal axis of the graph represents time and the vertical axis represents amplitude in FIG. 4. As shown in FIG. 4, the impulse response has distinguishable components including the direct sound component, the early reflection component, and the late reverberation component along the time axis.

The direct sound component is the sound that reaches the microphone 15 directly from the speaker 14; it has a high level of amplitude and appears earliest on the time axis. The late reverberation component is the component of the sound from the speaker 14 that reaches the microphone 15 after being repeatedly reflected in the room 100. This component is not so dependent on the position of the speaker 14 or microphone 15 in the room 100. The level of the late reverberation component at the end of the measured impulse response can be expressed by a common reverberation decay curve (for example, a decay curve obtained using the Schroeder integration). In this embodiment, the period of the extracted late reverberation component is a segment of the impulse response, starting from the end point and extending backward along the time axis to a point where the level deviates from the decay curve. In other words, the late reverberation component is the portion of the measured impulse response that follows the point of deviation.

The early reflection component is the part of the sound emitted by the speaker 14 that has been reflected once or multiple times on a desk, wall, ceiling, or floor of the room 100 before reaching the microphone 15. It is the portion of the impulse response that excludes the direct sound component and the late reverberation component. The level of each early reflection and the time at which it reaches the microphone 15 depend largely on the locations of the speaker 14 and microphone 15.

On the other hand, the late reverberation component and its frequency-amplitude characteristic depend more on the shape and size of the room 100 than on the locations of the speaker 14 and microphone 15. The late reverberation component includes standing wave components resulting from repeated reflections between opposite walls of the room 100. The processor 11 extracts the component after the predetermined time point onward in the measured impulse response, thereby obtaining a frequency-amplitude characteristic of a late reverberation component that contains many standing wave components.

Next, the processor 11 detects a difference between the frequency-amplitude characteristic of the extracted late reverberation component and a predetermined target characteristic (S13). The processor 11 obtains the frequency-amplitude characteristic of the late reverberation component extracted in step S12 by converting it into the frequency domain using a fast Fourier transform.

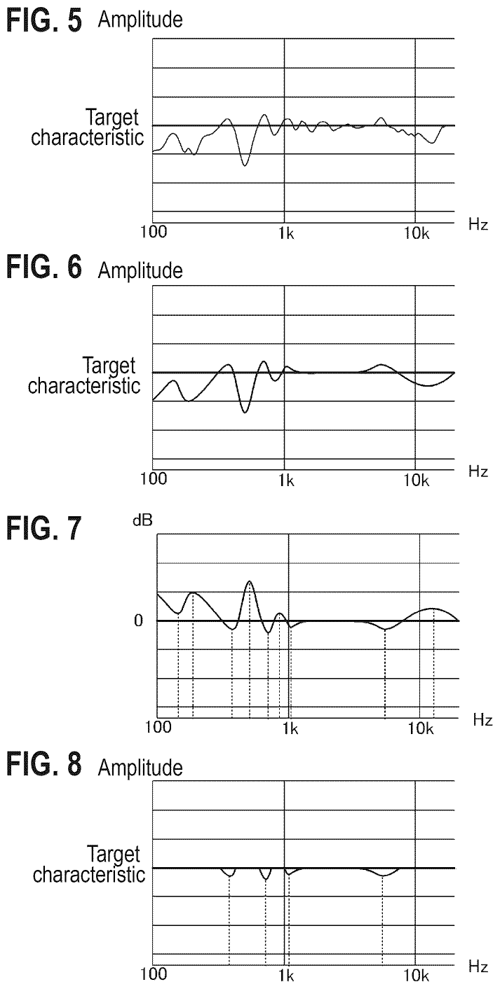

FIG. 5 shows an example of the frequency-amplitude characteristic of the extracted late reverberation component. The horizontal axis of the graph represents logarithmic frequency (Hz) and the vertical axis represents amplitude in FIG. 5. FIG. 5 shows an example of a flat target frequency characteristic representing a consistent amplitude across all frequencies. The target characteristic may take any form. For example, the target characteristic may include amplification or attenuation in a predetermined frequency band. Alternatively, the user may design the characteristic by freely adjusting the amplification or attenuation across various frequency bands.

The processor 11 may carry out smoothing on the extracted late reverberation component. FIG. 6 shows an example of the frequency-amplitude characteristic of the late reverberation component after smoothing. The frequency-amplitude characteristic shown in FIG. 6 has been smoothed to maintain a constant resolution when viewed on the logarithmic frequency axis. The processor 11 performs smoothing by obtaining a moving average over a predetermined bandwidth on the logarithmic frequency axis, for example. The smoothing process eliminates fine peaks and dips in the frequency-amplitude characteristic. This enables adjustment using a limited number of parametric equalizers (IIR filters) or adjustment using a short-tap FIR filter.

Alternatively, the processor 11 may extract the late reverberation component of the impulse response by multiplying the impulse response by a window function. The window function may include, in an early portion thereof, a first interval with the value being zero at a predetermined time point and gradually increasing with time.

As shown in FIG. 4, the amplitude of the impulse response reduces continuously over time. However, if a portion of the waveform after a predetermined time point of the impulse response is extracted as the late reverberation component, the waveform will appear discontinuous at that predetermined time point. Namely, the resultant impulse response, as a waveform of the late reverberation component, will exhibit a surge in amplitude starting from zero at that predetermined time point. This impulse response with the discontinuity, when converted into the frequency domain (frequency-amplitude characteristic) by using a fast Fourier transform, will contain errors due to the discontinuity (components that should not be present). In this embodiment, the processor 11 multiplies the measured impulse response by a window function that increases gradually with time after a predetermined time point as described above, before converting it to obtain the frequency-amplitude characteristic. This minimizes the errors in the resultant frequency characteristic that would otherwise result from the discontinuity in the early portion of the extracted late reverberation component.

The processor 11 may multiply the impulse response by a window function that includes, in addition to the first interval at the start, a second interval at the end where the value is zero at the last time point of the late reverberation component and gradually increases backward along the time axis.

The processor 11 generates a filter coefficient that achieves a frequency response including amplification or attenuation according to the difference between the target characteristic and the frequency-amplitude characteristic of the late reverberation component (S14). The processor 11 then sets this filter coefficient in the filter for processing audio signals fed to the speaker 14 (S15).

FIG. 7 shows an example of the frequency-amplitude characteristic of the filter (equalizer). The horizontal axis of the graph represents logarithmic frequency (Hz) and the vertical axis represents gain (dB) in FIG. 7.

The processor 11 adjusts the equalizer's frequency response to have a gain characteristic that compensates for the difference between the target characteristic and the frequency-amplitude characteristic of the late reverberation component, making it 0 dB. FIG. 7 shows an example of the frequency response of the equalizer that reduces (attenuates) peaks with amplitudes greater than the target characteristic by applying a gain below 0 dB and boosts (amplifies) dips with amplitudes lower than the target characteristic by applying a gain above 0 dB. For example, if the filter is designed as a parametric equalizer, the processor 11 sets the center frequency of each parametric equalizer band to match the frequency of each of the multiple dip or peak components indicated by the broken lines in FIG. 7.

The audio signal is processed by the filter thus set by the filter setting method of this embodiment before being fed to the speaker. Therefore, the influence of standing waves in the room where the speaker is installed can be eliminated from the sound emitted by the speaker. This allows the user to have a new customer experience of hearing a high-quality sound with less flutter echo.

The filter setting method of this embodiment extracts a late reverberation component, which is less affected by the microphone position, and generates a filter coefficient based on this late reverberation component, thereby allowing appropriate control of the standing waves of a room regardless of speaker and microphone positions.

According to Modification 1 of the filter setting method, in the step of generating a filter coefficient to be set in the filter, a filter coefficient that achieves a frequency response including attenuation according to the difference described above in frequency bands where the frequency-amplitude characteristic exceeds the target characteristic.

FIG. 8 shows an example of the frequency-amplitude characteristic of the filter (equalizer) according to Modification 1. As shown in FIG. 8, the processor 11 according to Modification 1 sets a filter coefficient that attenuates the signal only in frequency bands where the frequency-amplitude characteristic exceeds the target characteristic, thereby preventing sound quality degradation due to local dip correction. In the case with parametric equalizer filters, this enables efficient attenuation of standing waves with a limited number of bands.

In the step of generating a filter coefficient to be set in the filter, the processor 11 according to Modification 2 generates a filter coefficient that achieves a frequency response including attenuation according to the difference described above in frequency bands where the frequency-amplitude characteristic exceeds the target characteristic within a human hearing range (for example, 20 kHz).

The processor 11 according to Modification 2 improves the efficiency of standing wave attenuation by limiting the frequency range where the filter attenuation is applied to a user's hearing range.

In the step of generating a filter coefficient to be set in the filter, the processor 11 according to Modification 3 generates a filter coefficient that achieves a frequency response including attenuation according to the difference described above in frequency bands where the frequency-amplitude characteristic exceeds the target characteristic within a candidate range of low-order standing waves according to room dimensions.

The room dimensions are received from the user via the user I/F 18, for example. The processor 11 determines the lowest (fundamental) frequency at which a standing wave can be formed based on the room dimensions. For example, the processor 11 obtains the lowest (fundamental) frequency for standing waves by dividing the speed of sound by twice the distance between pairs of opposite walls of the room, considering the distance as half the wavelength. The processor 11 can improve the efficiency of standing wave attenuation by limiting the frequency range where the filter attenuation is applied to a candidate range that includes multiple low-order standing waves, from one to several times (for example, two to five times) the lowest (fundamental) frequency.

The processor 11 according to Modification 4 limits the gain of each frequency band of the filter to a predetermined range (for example, ±6 dB) that is narrower than the variable range of the gain. The processor 11 according to Modification 4 can thus minimize adverse effects on sound quality caused by over-adjustment.

The executing entity of the filter setting method is not limited to speaker devices. The filter setting method can be executed in any electronic device associated with indoor reproduction of audio signals, such as an electronic musical instrument, audio equipment, personal computer, smartphone, and game machine. Alternatively, the method can be executed using any combination of two or more electronic devices. The microphone, amplifier, and speaker may be equipped in each of the electronic devices, or may be provided separately.

For example, a microphone of external equipment such as a smartphone may be used to pick up a sound emitted by a speaker device (executing entity) and a signal representing the emitted sound may be generated. The captured sound signal is then transmitted to the speaker device, which may execute the filter setting process based on the received signal.

Alternatively, a smartphone (executing entity) delivering an audio signal to a speaker device (external equipment) may use its own microphone to pick up the sound emitted by the speaker device, and generate a signal representing the emitted sound. The smartphone may then generate a filter coefficient based on the captured sound signal and set it in the filter built in the speaker device.

The audio signal processed by the filter and reproduced by the speaker is not limited to the audio signal received by electronic equipment via the network I/F 16. The audio signal may be a digital audio signal converted from an analog audio signal picked up by a microphone or other equipment. The audio signal may be a digital audio signal that is generated from a sound source of an electronic musical instrument. The audio signal may be a digital audio signal that is read from the flash memory 12 of electronic equipment and reproduced.

The filtering can be performed by dedicated hardware such as a coprocessor or digital signal processor that is provided separately from the processor 11.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A filter setting method comprising:
measuring an impulse response of a room in which a speaker is placed;
extracting a late reverberation component of the measured impulse response;
detecting a difference between a frequency-amplitude characteristic of the extracted late reverberation component and a predetermined target characteristic;
generating a filter coefficient that achieves a frequency response including amplification or attenuation according to the difference; and
setting the filter coefficient in a filter configured to process an audio signal fed to the speaker.

2. The filter stetting method according to claim 1, wherein measuring the impulse response comprises:
emitting a sound from the speaker according to the audio signal;
generating a signal representing the emitted sound by picking up the emitted sound with a microphone; and
calculating the impulse response based on the audio signal and the signal representing the emitted sound.

3. The filter stetting method according to claim 2, comprising:
smoothing the frequency-amplitude characteristic to have a constant resolution when viewed on a logarithmic frequency axis.

4. The filter stetting method according to claim 2, comprising:
extracting the late reverberation component from the impulse response by cutting out a component after a predetermined time point of the impulse response.

5. The filter stetting method according to claim 2, wherein generating the filter coefficient to be set includes generating a filter coefficient that achieves a frequency response including attenuation according to the difference in frequency bands where the frequency-amplitude characteristic exceeds the target characteristic.

6. The filter stetting method according to claim 2, wherein generating the filter coefficient to be set includes generating a filter coefficient that achieves a frequency response including attenuation according to the difference in frequency bands where the frequency-amplitude characteristic exceeds the target characteristic within a human hearing range.

7. The filter setting method according to claim 2, wherein generating the filter coefficient to be set includes generating a filter coefficient that achieves a frequency response including attenuation according to the difference in frequency bands where the frequency-amplitude characteristic exceeds the target characteristic within a candidate range of low-order standing waves according to dimensions of the room.

8. The filter stetting method according to claim 1, comprising:
smoothing the frequency-amplitude characteristic to have a constant resolution when viewed on a logarithmic frequency axis.

9. The filter stetting method according to claim 1, comprising:
extracting the late reverberation component from the impulse response by cutting out a component after a predetermined time point of the impulse response.

10. The filter stetting method according to claim 9, comprising:
extracting the late reverberation component of the impulse response by multiplying the impulse response by a window function that includes, in an early portion thereof, a first interval where a value is zero at the predetermined time point and gradually increases with time.

11. The filter stetting method according to claim 1, wherein generating the filter coefficient to be set includes generating a filter coefficient that achieves a frequency response including attenuation according to the difference in frequency bands where the frequency-amplitude characteristic exceeds the target characteristic.

12. The filter stetting method according to claim 1, wherein generating the filter coefficient to be set includes generating a filter coefficient that achieves a frequency response including attenuation according to the difference in frequency bands where the frequency-amplitude characteristic exceeds the target characteristic within a human hearing range.

13. The filter setting method according to claim 1, wherein generating the filter coefficient to be set includes generating a filter coefficient that achieves a frequency response including attenuation according to the difference in frequency bands where the frequency-amplitude characteristic exceeds the target characteristic within a candidate range of low-order standing waves according to dimensions of the room.

14. A filter setting device comprising:
a processor configured to:
measure an impulse response of a room in which a speaker is placed;
extract a late reverberation component of the measured impulse response;
detect a difference between a frequency-amplitude characteristic of the extracted late reverberation component and a predetermined target characteristic;
generate a filter coefficient that achieves a frequency response including amplification or attenuation according to the difference; and
set the filter coefficient in a filter configured to process an audio signal fed to the speaker.

15. The filter stetting device according to claim 14, wherein the processor is configured to measure the impulse response by:
emitting a sound from the speaker according to the audio signal;
generating a signal representing the emitted sound by picking up the emitted sound with a microphone; and
calculating the impulse response based on the audio signal and the signal representing the emitted sound.

16. The filter stetting device according to claim 14, wherein the processor is configured to:
smooth the frequency-amplitude characteristic to have a constant resolution when viewed on a logarithmic frequency axis.

17. The filter stetting device according to claim 14, wherein the processor is configured to:
extract the late reverberation component from the impulse response by cutting out a component after a predetermined time point of the impulse response.

18. The filter stetting device according to claim 14, wherein the processor is configured to generate the filter coefficient to be set by generating a filter coefficient that achieves a frequency response including attenuation according to the difference in frequency bands where the frequency-amplitude characteristic exceeds the target characteristic.

19. The filter stetting device according to claim 14, wherein the processor is configured to generate the filter coefficient to be set by generating a filter coefficient that achieves a frequency response including attenuation according to the difference in frequency bands where the frequency-amplitude characteristic exceeds the target characteristic within a human hearing range.

20. A non-transitory computer-readable storage medium storing a program which, when executed by at least one processor, causes the at least one processor to:
measure an impulse response of a room in which a speaker is placed;
extract a late reverberation component of the measured impulse response;
detect a difference between a frequency-amplitude characteristic of the extracted late reverberation component and a predetermined target characteristic;
generate a filter coefficient that achieves a frequency response including amplification or attenuation according to the difference; and
set the filter coefficient in a filter configured to process an audio signal fed to the speaker.
